(19) United States
(12) Patent Application Publication
(10) Pub. No.: US 2026/0251439 A1
(43) Pub. Date: Aug. 27, 2026

(54) REAL-TIME CABLE SPEED AND DEPTH MEASUREMENTS BASED ON OPTICAL MEASUREMENTS

(71) Applicant: Schlumberger Technology Corporation, Sugar Land, TX (US)

(72) Inventors: Tyler Brandon, Sugar Land, TX (US); Lietian Ma, Sugar Land, TX (US); Richard Beaver, Houston, TX (US)

(21) Appl. No.: 18/993,053

(22) PCT Filed: Jul. 10, 2023
(86) PCT No.: PCT/US2023/027250

§ 371 Date: Jan. 10, 2025

Related U.S. Application Data
(60) Provisional application No. 63/368,206, filed on Jul. 12, 2022.

(51) Int. Cl. G01B 11/04; G01P 3/68; G06T 7/246; G06T 7/292

(52) U.S. Cl. CPC G01B 11/043; G01P 3/68; G06T 7/248; G06T 7/292; G06T 2207/10021; G06T 2207/20084; G06T 2207/30204; G06T 2207/30252

(57) ABSTRACT

Systems and methods are disclosed herein for optically measuring the speed of a cable, such as a cable being fed down a wellbore from a cable spool in an oil and gas operation. An example system can include a reference device having a known length that is statically mounted to a frame of the cable spool. The system can include at least two cameras statically mounted to the frame of the cable spool, with the cameras oriented such that their respective fields of view include both the reference device and a portion of the cable, such as a portion not on the spool but not yet downhole. The cameras can send images to a controller that can use triangulation to determine a distance the cable travels in a duration of time between images and calculate an estimated cable speed based on the determined distance and duration of time.

### CROSS-REFERENCE TO RELATED APPLICATIONS

This application claims priority to U.S. Provisional Patent Application No. 63/368,206, filed on Jul. 12, 2022, which is incorporated by reference herein.

### BACKGROUND

The present disclosure is related in general to measuring cable speed and depth, such as that used in conjunction with wellbore equipment including oilfield equipment, downhole assemblies, and the like.

In some oilfield and hydrocarbon related operations, tools can be advanced into a wellbore on a wireline cable to perform various operations, such as drilling, milling, and cutting, to name just a few examples. The operation of these tools often depends heavily on the depth and speed of the tool. As used herein, the terms “depth” or “cable depth” can refer to the depth of a tool or a depth of a particular portion of a cable supporting a tool, such as a connection point between the cable and tool. The terms “speed” or “cable speed” can refer to the linear speed of the tool or cable as it is being raised or lowered within a wellbore.

For example, a cutting or milling operation may need to be performed at a particular depth in order to perform the operation according to an engineering specification. Similarly, the speed at which a tool is lowered or raised within a wellbore can be a critical factor in some operations. A cutting or milling operation can, for example, require a tool to be moved within the wellbore at a particular speed in order to produce an acceptable result.

Currently, a mechanical apparatus is used to measure cable depth and speed. In one example, the cable is supported by an above-ground pulley that includes a sensor to measure the pulley's rotational speed. Based on the radius of the pulley and its rotation speed, a linear speed of the cable can be measured. This speed can be used for additional calculations to determine a cable depth. For example, if the tool is at the surface and is lowered at 1 inch per second, then after 1 minute the tool depth can be estimated as 60 inches deep.

The mechanical apparatuses currently used for cable depth and speed measurements are prone to error. For example, the pulley-based systems described above rely on the assumption that friction between the cable and the pulley will prevent slippage. However, in real-world scenarios a cable can be coated with water, oil, sand, or various drilling chemicals. Additionally, the cable can undergo large temperature variations based on the particular use. These various factors can result in a cable slipping on the pulley or even jumping off the pulley. When a cable slips on a pulley, the speed cannot be adequately calculated, which in turn makes any depth measurements inherently inaccurate. These errors can be compounded. That is, each cable slip can result in an error, and these errors can compound over time with additional slippage.

As a result, a need exists for new and improved methods of measuring cable speed and depth.

It is against this backdrop that the disclosed embodiments are described herein.

### SUMMARY

Systems and methods are disclosed herein for optically measuring the speed of a cable, such as a cable being fed down a wellbore from a cable spool in an oil and gas operation. An example system can include a reference device having a known length that is statically mounted to a frame of the cable spool, for use in comparing cable movement against the known length. The cable spool can be mounted within a wireline truck, for example. The system can include at least two cameras statically mounted to the frame of the cable spool, or elsewhere on the truck, with the cameras oriented such that their respective fields of view include both the reference device and a portion of the cable, such as a portion not on the spool but not yet downhole. The reference device can be a portion of the wireline truck in an example.

The cameras can send images to a controller that can use triangulation to determine a distance the cable travels in a duration of time between images. The images can be captured from a video feed and can include timestamps for comparison purposes. The determination can include analyzing multiple consecutive images received from the cameras. Based on the analysis, the controller can calculate an estimated cable speed based on the determined distance and duration of time. The controller can use the estimated cable speed to calculate an estimated cable depth, such as by summing consecutive time periods using the cable speed for each of those time periods.

The controller can display various types of data on a graphical user interface (“GUI”) at the surface of the worksite. For example, an operator's computing device, such as a smartphone or tablet, can display the GUI. In other examples, the GUI can be a display mounted to the truck, the cable spool, or at a remote location. The GUI can display views of the cameras, real-time cable speed, and real-time cable depth. The GUI can also display historical information, such as previous camera views, previous cable speeds, and previous cable depths. The GUI can also indicate a remaining length of wire on the spool.

Additionally, example methods are disclosed that can utilize the systems disclosed herein. An example method can include providing a reference device statically mounted to a frame of a cable spool and providing at least two cameras also statically mounted to that frame. The cameras can be oriented such that their fields of view include both the reference device and the cable. The example method can further include capturing images by the cameras and transmitting the images to a controller. Further, the method can include triangulating the images, determining a distance that the cable has traveled in a duration of time between images, and calculating an estimated cable speed based on the determined distance and duration.

An example non-transitory, computer-readable medium is also described. The medium can include instructions that, when executed by a hardware-based processor of a computing device, performs various stages. The stages can include receiving images from at least two cameras statically mounted to a frame of a cable spool, the images including both a cable and a reference device statically mounted to the frame. The stages can further include triangulating the images from the at least two cameras, determining a distance that the cable has traveled in a duration of time between images, and calculating an estimated cable speed based on the determined distance and duration of time.

This summary section is not intended to give a full description of the disclosed systems and methods.

### BRIEF DESCRIPTION OF THE DRAWINGS

The embodiments of the present invention are illustrated by way of example, and not by way of limitation, in the figures of the accompanying drawings and in which like reference numerals refer to similar elements. The disclosure is best understood from the following detailed description when read with the accompanying figures. It is emphasized that, in accordance with standard practice in the industry, various features are not drawn to scale. In fact, the dimensions of various features may be arbitrarily increased or reduced for clarity of discussion.

FIG. 1 provides an illustration of an example system for optically measuring the speed of a cable feeding from a cable spool.

FIG. 2 provides an illustration of a portion of the example system of FIG. 1, showing camera fields of view.

FIG. 3 provides a flow chart of an example method for optically measuring the speed of a cable feeding from a cable spool.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact and may also include embodiments in which additional features may be formed interposing the first and second features, such that the first and second features may not be in direct contact.

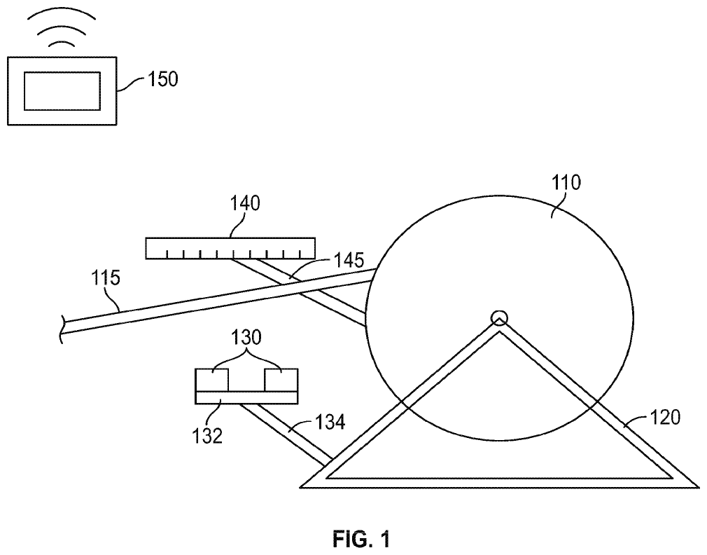

FIG. 1 shows an example system for optically measuring the speed of a cable 115, such as a cable 115 being fed down a wellbore from a cable spool 110 in an oil and gas operation. The system includes a reference device 140 having a known length that is statically mounted to a frame 120 of the cable spool via a mounting bracket 145, for use in comparing cable 115 movement against the known length. The cable spool 110 can be mounted within a wireline truck, for example. The system includes two cameras 130 statically mounted to the frame 120 of the cable spool 110, with the cameras 130 oriented such that their respective fields of view include both the reference device 140 and a portion of the cable 115, such as a portion not on the spool but not yet downhole. The cameras 130 can be mounted to a mounting plate 132 which is in turn mounted to the frame 120 via a mounting bracket 134, for example. The reference device 140 can be a portion of the wireline truck in an example.

The cameras 130 can send images to a controller 150 that can use triangulation to determine a distance the cable 115 travels in a duration of time between images. The images can be captured from a video feed and can include timestamps for comparison purposes. The determination can include analyzing multiple consecutive images received from the cameras 130. Based on the analysis, the controller 150 can calculate an estimated cable speed based on the determined distance and duration of time. The controller 150 can use the estimated cable speed to calculate an estimated cable depth, such as by summing consecutive time periods using the cable speed for each of those time periods.

The controller 150 can display various types of data on a graphical user interface (“GUI”) at the surface of the worksite. For example, an operator's computing device, such as a smartphone or tablet, can display the GUI. In other examples, the GUI can be a display mounted to the truck, the cable spool 110, 120, or at a remote location. The GUI can display views of the cameras 130, real-time cable speed, and real-time cable depth. The GUI can also display historical information, such as previous camera views, previous cable speeds, and previous cable depths. The GUI can also indicate a remaining length of cable 115 on the spool 110.

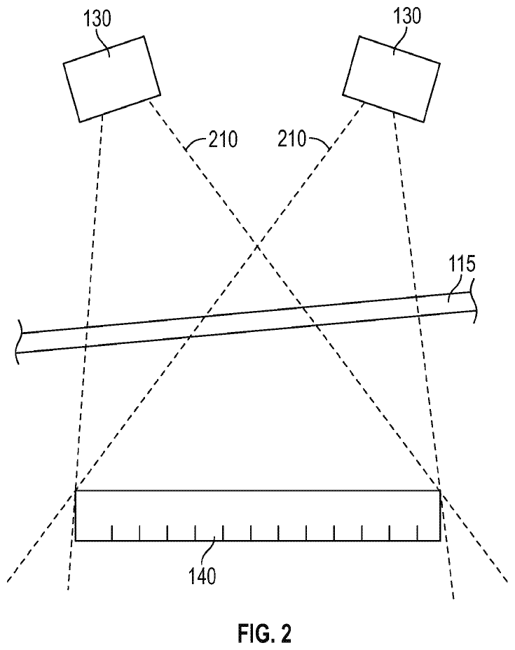

FIG. 2 shows an illustration of a portion of the example system of FIG. 1, showing cameras 130 and their respective fields of view 210. As shown, each field of view 210 captures a portion of the cable 115 as well as the reference device 140. Additionally, the cameras 130 are shown in slightly different locations, with slightly different angles relative to the reference device 140. These differing views can allow for triangulation methods to calculate the distance the cable 115 moves over a period of time, relative to the reference device 140.

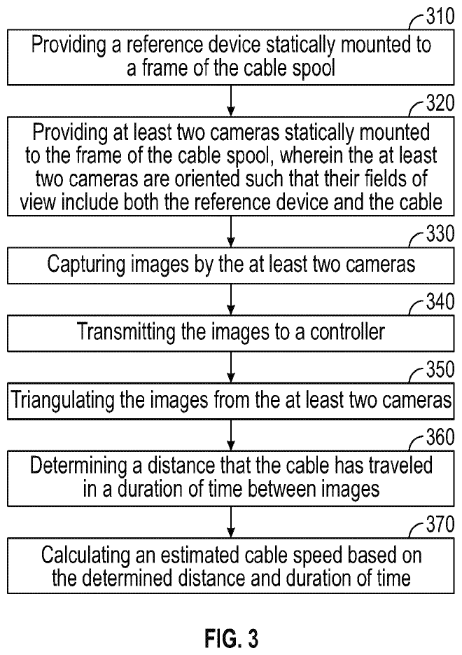

FIG. 3 provides a flow chart of an example method for optically measuring the speed of a cable 115 feeding from a cable spool 110. Stage 310 can include providing a reference device 140 statically mounted to a frame of a cable spool 110. Stage 320 can include providing at least two cameras 130 also statically mounted to that frame 120. The cameras 130 can be oriented such that their fields of view include both the reference device 140 and the cable 115. Stage 330 can include capturing images by the cameras 130, while stage 340 can include transmitting the images from the cameras 130 to a controller.

Stage 350 can include triangulating the images by the controller. At stage 360, the controller can determine a distance that the cable 115 has traveled in a duration of time between images. At stage 370, the controller can calculate an estimated cable speed based on the determined distance and duration of time.

The preceding description has been presented with reference to present embodiments. Persons skilled in the art and technology to which this disclosure pertains will appreciate that alterations and changes in the described structures and methods of operation can be practiced without meaningfully departing from the principle, and scope of this invention. Accordingly, the foregoing description should not be read as pertaining only to the precise structures described and shown in the accompanying drawings, but rather should be read as consistent with and as support for the following claims.

What is claimed is:

1. A system for optically measuring the speed of a cable feeding from a cable spool, comprising:
a reference device statically mounted to a frame of the cable spool;
at least two cameras statically mounted to the frame of the cable spool, wherein the at least two cameras are oriented such that their respective fields of view include both the reference device and the cable;
a controller that receives images from the at least two cameras, the controller configured to carry out stages comprising:
triangulating the images from the at least two cameras;
determining a distance that the cable has traveled in a duration of time between images; and
calculating an estimated cable speed based on the determined distance and duration of time.

2. The system of claim 1, wherein determining the distance includes analyzing multiple consecutive images received from the at least two cameras.

3. The system of claim 1, wherein the reference device is a known length and is used for comparing cable movement between frames of the images.

4. The system of claim 1, wherein the images are captured from a video feed.

5. The system of claim 1, wherein the controller calculates an estimated cable depth based on the estimated cable speed over time.

6. The system of claim 1, wherein the controller causes a graphical user interface (“GUI”) to display at least one of the estimated cable speed and an estimated cable depth.

7. The system of claim 1, wherein the at least two cameras are mounted on a common mounting frame that is mounted to the frame of the cable spool.

8. The system of claim 1, wherein the cable spool is mounted to a truck.

9. The system of claim 1, wherein the controller utilizes a machine learning algorithm for at least one of determining the distance or calculating the estimated cable speed.

10. A method for optically measuring the speed of a cable feeding from a cable spool, comprising:
providing a reference device statically mounted to a frame of the cable spool;
providing at least two cameras statically mounted to the frame of the cable spool, wherein the at least two cameras are oriented such that their fields of view include both the reference device and the cable;
capturing images by the at least two cameras;
transmitting the images to a controller;
triangulating the images from the at least two cameras;
determining a distance that the cable has traveled in a duration of time between images; and
calculating an estimated cable speed based on the determined distance and duration of time.

11. The method of claim 10, wherein determining the distance includes analyzing multiple consecutive images received from the at least two cameras.

12. The method of claim 10, wherein the reference device is a known length and is used for comparing cable movement between frames of the images.

13. The method of claim 10, wherein the images are captured from a video feed.

14. The method of claim 10, wherein the controller calculates an estimated cable depth based on the estimated cable speed over time.

15. The method of claim 10, wherein the controller causes a graphical user interface (“GUI”) to display at least one of the estimated cable speed and an estimated cable depth.

16. The method of claim 10, wherein the at least two cameras are mounted on a common mounting frame that is mounted to the frame of the cable spool.

17. The method of claim 10, wherein the cable spool is mounted to a truck.

18. The method of claim 10, wherein the controller utilizes a machine learning algorithm for at least one of determining the distance or calculating the estimated cable speed.

19. A non-transitory, computer-readable medium comprising instructions that, when carried out by a processor, causes the processor to perform stages comprising:
receiving images from at least two cameras statically mounted to a frame of a cable spool, the images including both a cable and a reference device statically mounted to the frame;
triangulating the images from the at least two cameras;
determining a distance that the cable has traveled in a duration of time between images; and
calculating an estimated cable speed based on the determined distance and duration of time.

20. The non-transitory, computer-readable medium of claim 19, the stages further comprising calculating an estimated cable depth based on the estimated cable speed over a time period.
